(19) United States
(12) Patent Application Publication
(10) Pub. No.: US 2025/0001514 A1
(43) Pub. Date: Jan. 2, 2025

(54) START OF WELD PROCEDURE

(71) Applicant: The ESAB Group, Inc., North Bethesda, MD (US)

(72) Inventors: Lars David Leif Juliusson, Västra Frölunda (SE); Karl Jakob Erik Lennartsson, Göteborg (SE); Rastislav Kubicek, Göteborg (SE); Patrik Wadström, Kungälv (SE); Daniel Karlsson, Kungsängen (SE); Bo Daniel Lennartsson, Örebro (SE)

(21) Appl. No.: 18/595,862

(22) Filed: Mar. 5, 2024

Related U.S. Application Data
(60) Provisional application No. 63/510,901, filed on Jun. 29, 2023.

(51) Int. Cl. B23K 9/095; B23K 9/067; B23K 9/09; B23K 9/173

(52) U.S. Cl. CPC B23K 9/0953; B23K 9/067; B23K 9/09; B23K 9/173

(57) ABSTRACT

In an embodiment, a method performed by a welding or cutting system having a power supply to supply weld power to an electrode tip extending from a welding torch, comprises: upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and when the weld energy reaches the weld energy threshold, performing a welding operation on the workpiece.

### CLAIM TO PRIORITY

This application claims priority to U.S. Provisional Application No. 63/510,901, filed Jun. 29, 2023, the entirety of which is incorporated herein by reference.

### TECHNICAL FIELD

The present disclosure relates to starting a welding operation.

### BACKGROUND

Gas Metal Arc Welding (GMAW) including Metal Inert Gas (MIG) welding and Metal Active Gas (MAG) (MIG/MAC) welding involves supplying power in the form of current and voltage to a consumable wire electrode to form an electric arc between a tip of the wire electrode (i.e., the “electrode tip”) and a workpiece on which melted welding material from the electrode tip is deposited, and which forms a weld when cooled. At the start of a welding operation, a number of electrical and physical conditions (referred to as “initial conditions”) exist, including the current and the voltage supplied to the electrode tip, a length of an arc (i.e., an “arc length”) extending from the electrode tip to the workpiece, temperatures of the electrode tip and the workpiece, and melt conditions at the electrode tip. The initial conditions affect the characteristics and quality of the weld produced by the welding operation. The initial conditions can vary substantially from one welding operation to the next. Therefore, the characteristics and quality of the welds produced from one welding operation to the next can vary substantially, which leads to unreliable and non-uniform or inconsistent weld results.

### BRIEF DESCRIPTION OF THE DRAWINGS

FIG. 1 is an illustration of an example welding system in which embodiments directed to a start of weld procedure may be implemented.

FIG. 2 is a block diagram of a power supply and a power supply controller (PSC) of the welding system, according to an example embodiment.

FIG. 3 is a high-level flowchart of an example method of performing the start of weld procedure.

FIG. 4 shows weld power waveforms (i.e., current and voltage waveforms) for an example start of weld procedure for short-arc welding.

FIG. 5 shows weld power waveforms for an example start of weld procedure for pulsed or spray arc welding.

FIG. 6 shows weld power waveforms for an example short-circuit clearing technique.

FIG. 7A shows weld power waveforms for an example droplet clearing technique.

FIG. 7B is a flowchart of an example method of performing a start of weld procedure in a welding or cutting system.

FIG. 8 is a diagram of the PSC accordance to an embodiment.

### DETAILED DESCRIPTION

### Overview

In an embodiment, a method performed by a welding or cutting system having a power supply to supply weld power to an electrode tip extending from a welding torch, comprises: upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and when the weld energy reaches the weld energy threshold, performing a welding operation on the workpiece.

### Example Embodiments

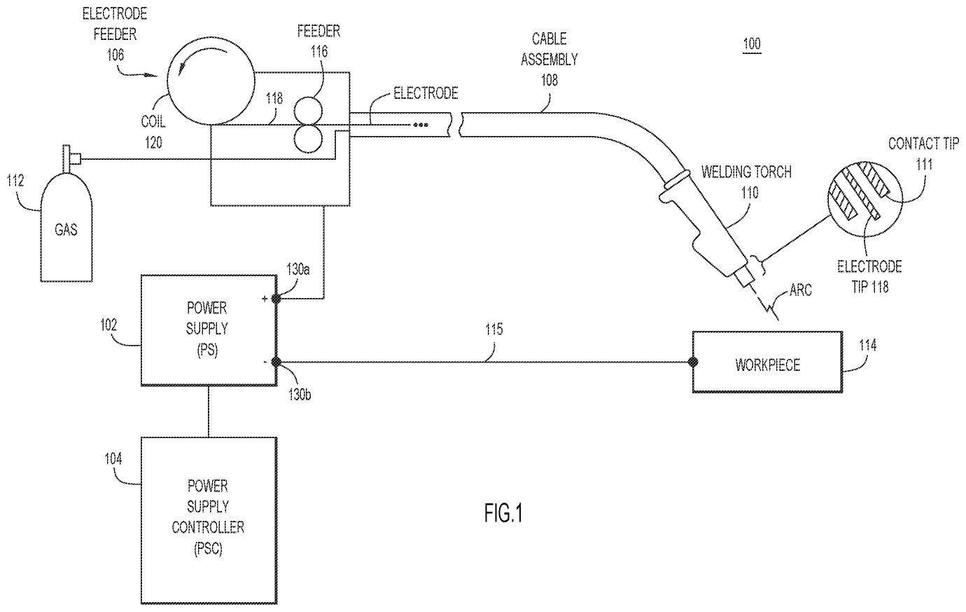

With reference to FIG. 1, there is an illustration of an example metal inert gas (MIG)/metal active gas (MAG) welding system 100, in which a start of weld procedure may be implemented. The embodiments are presented in the context of MIG/MAG welding by way of example only. It is understood that the embodiments may be employed generally in any known or hereafter developed welding environments, such as, but not limited to, tungsten inert gas (TIG) welding, flux cored arc welding (FCAW), shielded metal arc welding (SMAW) or stick welding, submerged arc welding (SAW), and so on. Additionally, the embodiments may be employed equally in an arc cutting apparatus. Welding system 100 includes: a power supply 102; a power supply controller (PSC) 104 coupled to and configured to control the power supply; an electrode feeder 106 coupled to the power supply; a cable assembly 108 coupled to the electrode feeder; a welding torch 110 (also referred to as a “welding gun”) coupled to the cable assembly and having a sturdy metal contact tip 111 that extends from an end of the welding gun or torch; a gas container 112 coupled to the cable assembly; and a workpiece 114 coupled to the power supply through at least a return path/cable 115. In the ensuing description, the terms “weld” and “welding” are synonymous and interchangeable. Also, the terms “weld” and “welding” refer broadly to both welding and plasma cutting systems and operations.

Electrode feeder 106 includes an electrode feeder 116 to feed an electrode from a coiled electrode 120 through cable assembly 108 and through contact tip 111 of welding torch 110, which is in electrical contact with the electrode. Under control of PSC 104, power supply 102 generates weld power that drives the welding process. In welding processes that involve a pulsed or periodic waveform, the weld power typically includes a series of weld current pulses. Power supply 102 provides the weld power from an output terminal 130a of the power supply to the electrode, through electrode feeder 116, cable assembly 108, and welding torch 110, while the cable assembly also delivers a shielding gas from gas container 112 to the welding torch. Return path/cable 115 provides an electrical return path from workpiece 114 to an input terminal 130b of power supply 102

During a welding process, an electrode tip 118 of the electrode is brought into contact or near contact with workpiece 114, and the weld power (i.e., weld current and weld voltage) supplied by power supply 102 to the welding torch creates an arc between workpiece 114 and electrode tip 118 (also referred to as an “electrode stick”) extending through the contact tip. To control the welding process, PSC 104 controls power supply 102 to generate the weld power (e.g., weld current) at a desired level for the welding process, based on feedback in the form of measurements of the weld current and weld voltage (e.g., arc voltage) supplied by the power supply to the welding process. The measurements may be produced by current and voltage sense points in power supply 102 and/or at sense points that are remote from the power supply, such as in cable assembly 108 or welding torch 110.

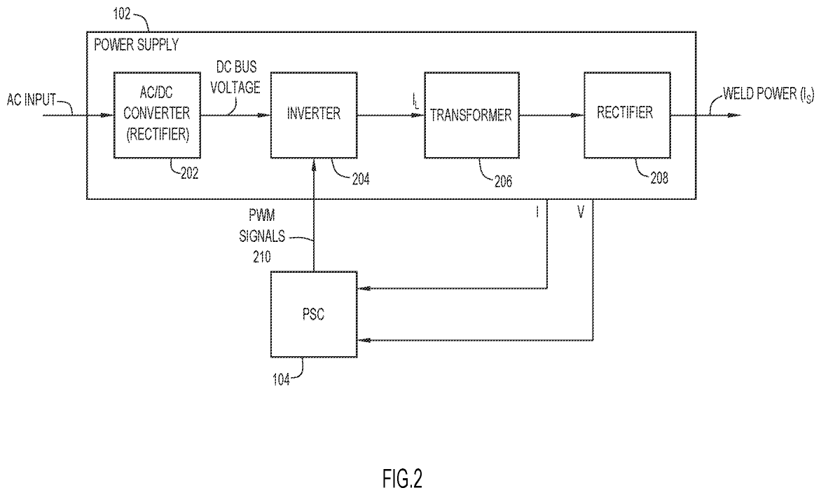

FIG. 2 is a block diagram of power supply 102 with PSC 104, according to an embodiment. Power supply 102 includes an AC/DC converter 202 to receive AC input power (e.g., from AC mains or a generator), a power inverter (referred to simply as an “inverter”) 204, a high-frequency transformer 206, and a rectifier 208 coupled to one another. AC/DC converter 202 includes a diode rectifier to convert the AC input power to a constant, rectified DC voltage (also referred to as a DC “bus” voltage), and provide the DC bus voltage to an input of inverter 204. Under control of PSC 104, inverter 204, transformer 206, and rectifier 208 collectively operate as a weld process regulator to convert the DC bus voltage to a desired weld power supplied by power supply 102 for a welding process.

Inverter 204 comprises a set of high-speed semiconductor switching devices (i.e., power switches) that are pulse width modulated (i.e., switched on and off at a switching frequency) responsive to pulse width modulation (PWM) waveforms 210 (also referred to as “PWM signals”), generated by PSC 104 and applied to control terminals of the switching devices, to convert the DC bus voltage to an AC (power) signal or waveform including a voltage and a primary current I_{L}, that flows into transformer 206. Such operation is referred to as “PWM operation” of inverter 204. Example switching frequencies may be in a range from 1 kHz-100 kHz, although other switching frequencies above and below this range may be used. Inverter 204 supplies the AC signal to transformer 206. Transformer 206 converts the voltage and current of the AC signal from inverter 204 to a transformed AC signal having desired levels of a voltage and a secondary current I_{S} for the welding process, and supplies the transformed AC signal to rectifier 208. Rectifier 208 rectifies the transformed AC signal to produce the weld power based on the secondary current I_{S} and supplies the same to the welding process.

As shown in FIG. 2, power supply 102 includes a current sense point to provide to PSC 104 a sensed current I (i.e., a sensed weld current) that represent secondary current I_{S} or primary current I_{L}, for example, produced by the power supply 102. Power supply 102 also includes a voltage sense point to provide to PSC 104 a sensed voltage V (i.e., a sensed weld voltage) representative of a voltage produced by the power supply (e.g., a voltage across the power supply terminals, the arc voltage, and the like). The sensed current and voltage represent current and voltage measurements (i.e., measured current and voltage) of the weld power, which provide real-time feedback from the welding process to PSC 104.

PSC 104 receives the current and voltage measurements. To control primary current I_{L} (and correspondingly secondary current I_{S}) generated by power supply 102, PSC 104 controls or dynamically adjusts PWM waveforms 210 applied to inverter 204 based on desired or target settings (i.e., set points) for primary current (or secondary current), voltage, energy/power, and based on the current and/or voltage measurements from the welding process. For example, PSC 104 may increase an on-time of cycles of PWM waveforms 210 applied to inverter 204 to increase primary/secondary current I_{L}/I_{S}, and vice versa. In this way, PSC 104 implements a sample-based feedback control loop to control PWM waveforms 210 based on the current and voltage measurements.

Embodiments presented herein are directed to a start of weld procedure that includes preparatory stages lead into a welding phase (also referred to as the “welding operation”). In the ensuing description, weld power, weld current, and weld voltage may be referred to simply as power, current, and voltage, respectively. It is also understood that monitoring/measuring/sensing weld current and/or weld voltage is a form of monitoring/measuring/sensing weld power because weld power is a function of the weld voltage and the weld current. The start of weld procedure establishes consistent initial conditions for the welding phase. The initial conditions include a predetermined arc length from the electrode tip to the workpiece, a predetermined heating of the electrode tip and the workpiece to certain temperatures, and melt conditions of the electrode and the workpiece that collectively lead to success of the welding phase. When the start of weld procedure repeats, the start of weld procedure produces consistent and uniform initial conditions from one weld phase to the next, which leads to consistent and uniform weld results. That is, each welding phase starts from a known state and with few variations to yield reliable dependable results weld after weld.

At a high level, the start of weld procedure includes an event-driven sequence of distinct phases, including (i) an ignition phase, (ii) an arc-length phase, and (iii) a heat phase, leading into (iv) a MIG/MAG welding phase/operation. The start of weld procedure transitions through the sequence of distinct phases, one phase to the next, responsive to detecting a sequence of distinct triggers/events. The ignition, arc-length, and heat phases may be considered preparatory or initial phases leading into the welding phase. The preparatory phases ensure that the welding phase starts from/in a known state with minimum variation from welding phase to welding phase. The start of weld procedure may have a total duration of only a fraction of a second, for example. The start of weld procedure receives and monitors measurements of the current and the voltage (e.g., the arc voltage) as applied to the overall welding process. The measurements of the current and/or voltage indicate directly or indirectly distinct triggers or events that trigger transitions from one phase of the start of weld procedure to the next.

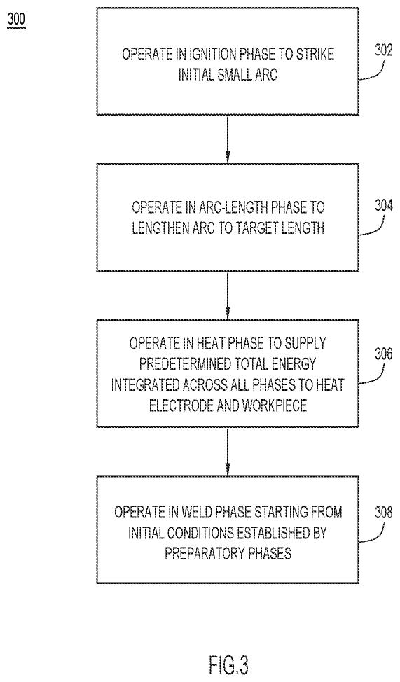

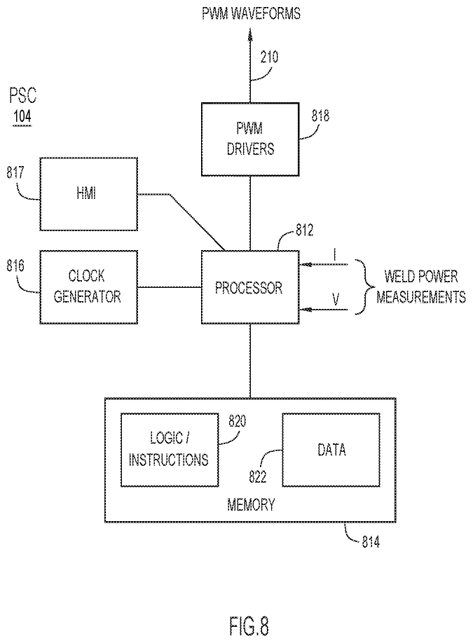

FIG. 3 is a high-level flowchart of example operations 300 of the start of weld procedure. Prior to the start of weld procedure, an operator may enter weld parameters into a human machine interface (HMI) integrated with PSC 103 (as described below in connection with FIG. 8) to set the stage for welding operations that occur after the start of weld procedure. Such weld parameters may include, but are not limited to, a weld current setting, a weld voltage setting, a type of electrode, electrode dimensions, the type of weld process selected (e.g., MIG/MAG), the type of weld method, a weld current, and a weld voltage, for example.

Prior to and throughout the start of weld procedure, PSC 104 monitors and controls the current and voltage (i.e., weld current and weld voltage) supplied to the welding process to initiate and implement the sequence of phases of the start of weld procedure. PSC 104 may repeatedly compute and monitor a time derivative of the voltage (i.e., a voltage derivative), and an integrated weld energy (i.e., weld power over time) supplied to the welding process, which the PSC may use to trigger transitions between phases. The term “weld energy” may be referred to simply as “energy” below.

Once triggered, at 302, the start of weld procedure initially operates in the ignition phase. Detection of a weld start condition triggers/starts the ignition phase. For example, detection of a good ohmic connection/short-circuit between the electrode and the workpiece (e.g., when the two are touching each other) starts the ignition phase. To detect contact in one example, the ignition phase monitors the voltage derivative and detects the touch when the voltage derivative falls below a voltage derivative threshold. Once started, the ignition phase rapidly increases the current to a high constant current level to strike an initial small arc between the electrode (tip) and the workpiece. While the current increases, the voltage between the electrode tip and the workpiece increases more gradually. When the voltage increases to a first voltage threshold (e.g., equal to an anode-cathode voltage drop indicative of the presence of the small arc, the ignition phase ends, and the arc-length phase starts, i.e., the ignition phase transitions to the arc-length phase.

At 304, the start of weld procedure operates in the arc-length phase and performs the following operations/actions while operating in (i.e., during) that phase. An aim of the arc-length phase is to elongate or grow the arc to a length that allows weld power to be dissipated safely without short-circuits during the subsequent phase (i.e., the heat phase). To this end, the arc-length phase expands/lengthens the initial small arc established by the ignition phase to a predetermined or target length suitable for the welding phase. To do this, the arc-length phase controls the weld power with the aim of causing the arc length to reach the target arc length. In a non-limiting example, the arc-length phase decreases the current from an initially high/ramped-up level at the end of the ignition phase, while the voltage increases more or less linearly as the arc length increases due to melting of the electrode tip. Other techniques for controlling the power may be used. When the voltage has risen to or exceeds a second voltage threshold corresponding to the target length, the arc-length phase ends, and the heat phase starts. The second voltage threshold is greater than the first voltage threshold.

The arc-length phase may employ a short-circuit clearing technique to clear an undesired short-circuit between the electrode tip and the workpiece that arises when insufficient weld power is applied during the arc-length phase. This can occur when the weld power applied to the arc is insufficient to counter the wire feed speed, thus leading to the short-circuit. Upon detecting the short-circuit, the arc-length clearing technique rapidly increases weld power applied to the process to form a droplet at the electrode tip. Upon detecting the droplet (e.g., by finding a point in time when a value of the voltage derivative indicates that the droplet is forming), the technique decreases the weld power. The heat phase described below similarly employs the short-circuit clearing technique to clear any undesired short-circuit between the electrode tip and the workpiece that might arise when insufficient weld power is applied during the heat phase.

At 306, the start of weld procedure operates in the heat phase and performs the following operations/actions while operating in (i.e., during) that phase. The heat phase continues to supply weld energy (e.g., weld power over time) to the electrode tip to ensure that a total weld energy across all of the ignition, arc-length, and heat phases is sufficient to establish consistent, desired heat/melt conditions of the workpiece and the electrode tip leading directly into the welding phase. That is, the heat phase ensures that the electrode tip and the workpiece both reach a certain temperature suitable for starting the welding phase. Specifically, the heat phase continues to apply weld energy/power to form a small weld pool of melted electrode material on the workpiece and a decent-sized molten droplet on the electrode tip—collectively referred to as the melt conditions or state of the electrode. For a cold start, the heat phase may last for a relatively long time period, in contrast to a non-cold start.

The heat phase may be regulated to hold a substantially constant voltage over the arc. For example, the heat phase may employ constant voltage (CV) control or regulation. An input setting for the arc voltage may be synergic (based on wire material/thickness/wire feed speed (WFS)) with, and proportional to, normal welding (i.e., in the subsequent welding phase) for that wire feed speed. During the ignition, arc-length, and heat phases, the weld energy supplied to the process is integrated, to produce an integrated weld energy. When the integrated weld energy across the three phases meets a predetermined weld energy threshold (also referred to as a predetermined “total weld energy”), the heat phase ends, and the welding phase starts, i.e., the start of weld procedure transitions to the welding phase. The weld energy threshold and temperature corresponding to that energy may be referred to as the “welding phase condition” that is met to transition to the welding phase. Values of the weld energy threshold may be determined empirically for different types of electrodes by determining an amount of weld energy employed to heat a given electrode and workpiece to target temperatures that established desired melt conditions (mentioned above) that lead to good welds. The values may be stored in a database in memory for subsequent lookup prior to executing the start of weld procedure using a given type of electrode.

The heat phase may employ a large droplet release technique under certain conditions. In a spray-arc welding process, the weld power applied to lengthen the arc, melt the electrode, and continue to heat the electrode during the heat phase may cause a large molten droplet to form at, and hang off, of the electrode tip. The large droplet release technique applies a sequence of short current pulses to release the droplets, one pulse per droplet, without risking a globular transfer or a short-circuit.

At 308, the start of weld procedure operates in the welding phase and performs the following operations/actions while operating in (i.e., during) that phase. Consistent initial conditions (e.g., arc length and temperature) for the welding phase are established by the preceding ignition, arc-length, and heat phases. Starting with the initial conditions, the welding phase employs a known short-arc current/voltage configuration for short-arc MIG/MAG welding, or employs a known pulsed or spray type current/voltage configuration for MIG/MAG welding.

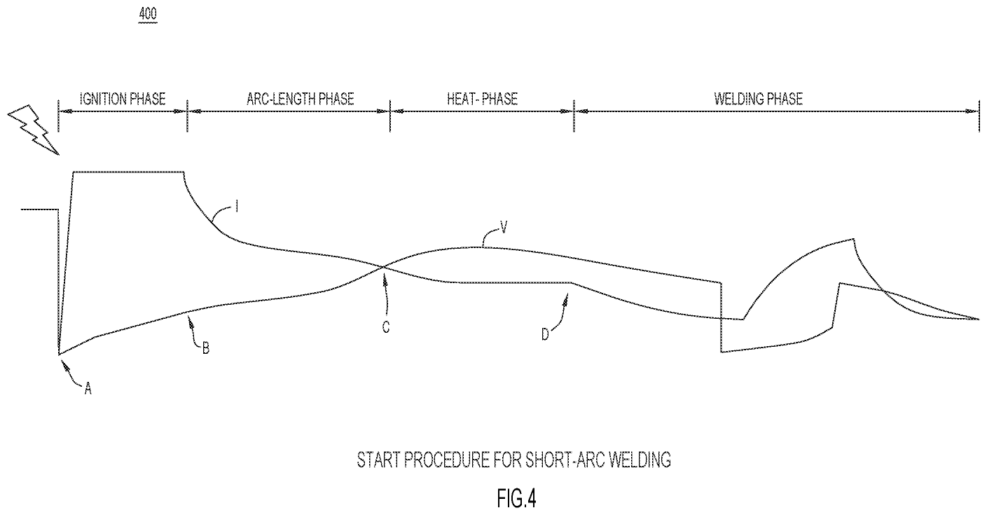

Described below are FIGS. 4-7A, which show current and voltage waveforms for start of weld procedures for different welding process scenarios. Like labels used across FIGS. 4-7A show or indicate like features.

FIG. 4 shows waveforms for current I and voltage V (e.g., arc voltage) of an example start of weld procedure 400 for short-arc welding. The top of FIG. 4 shows a time-ordered sequence of ignition, arc-length, heat, and welding phases of start of weld procedure 400. The following events/triggers are depicted in FIG. 4:
a. The ignition phase starts at A when contact between the electrode tip and the workpiece is detected as a substantial rapid voltage drop. In response, current I is rapidly ramped up to a constant level to strike an initial arc. The arc is detected at B when arc voltage V exceeds a first voltage threshold, which ends the ignition phase and starts the arc-length phase.
b. The arc-length phase starts at B. Sufficient weld power is supplied while arc voltage V is increased to lengthen the arc, until, at C, the arc voltage exceeds a second voltage threshold (which is indicative of a target arc length). This ends the arc-length phase and starts the heat phase.
c. The heat phase starts at C. The power supplied to the process is at a substantially constant level until D, when the integrated weld energy meets a predetermined weld energy threshold (i.e., a predetermined total weld energy across all phases). This establishes desired temperatures of the electrode and the workpiece.
d. The welding phase starts at D.

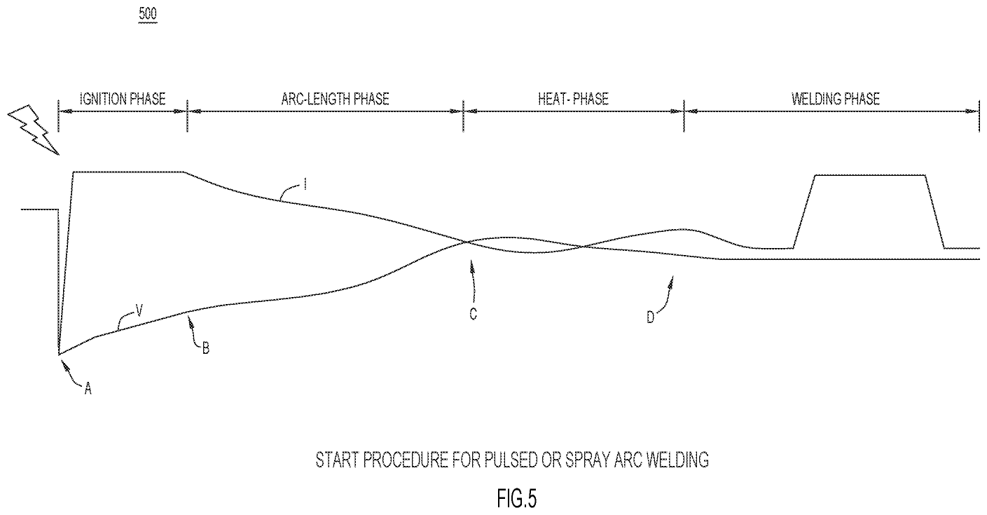

FIG. 5 shows waveforms for current I and voltage V of an example start of weld procedure 500 for a pulsed or spray arc welding process. The ignition phase starts at A when contact between the electrode tip and the workpiece is detected. In response, current I is rapidly ramped up to a constant level to strike an initial arc. The arc is detected at B when arc voltage V exceeds a first voltage threshold, which ends the ignition phase and starts the arc-length phase. The arc-length phase starts at B. Sufficient weld power is supplied while arc voltage V is increased to grow the arc length, until, at C, the arc voltage exceeds a second voltage threshold (which is indicative of a target arc length). This ends the arc-length phase and starts the heat phase. The heat phase starts at C. The voltage is supplied to the process at a substantially constant level until D, when the integrated weld energy meets a predetermined weld energy threshold. This establishes desired temperatures of the electrode and the workpiece. The welding phase starts at D.

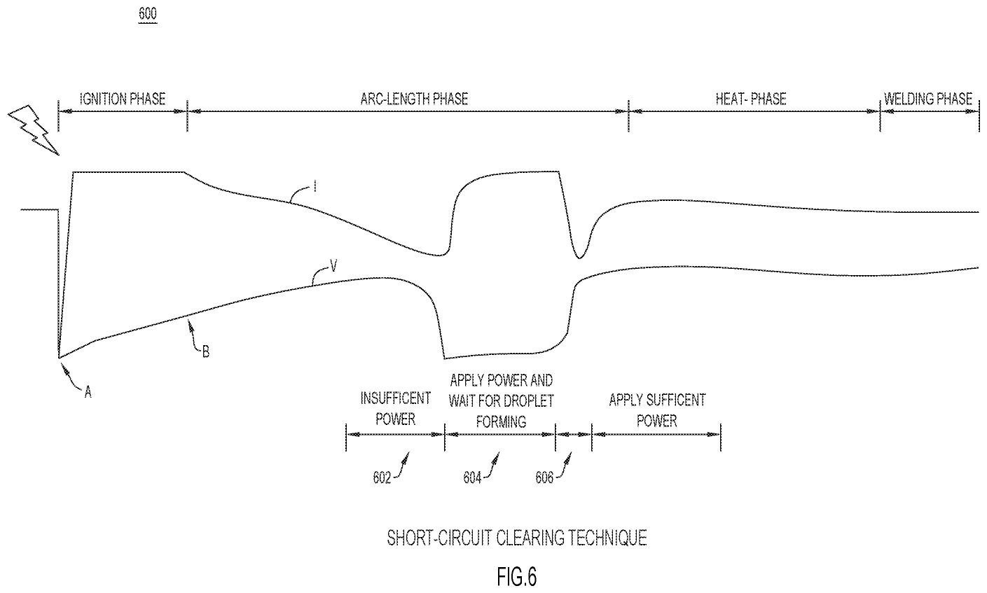

FIG. 6 shows waveforms for current I and voltage V for an example short-circuit clearing technique 600. At 602, an undesired short-circuit due to insufficient weld power is detected. The short-circuit may be detected as a sudden drop in voltage V, or a when the voltage derivative falls below a voltage derivative threshold, for example. At 604, an increase in weld power is applied while the process waits for a droplet to form. At 606, the droplet is detected and weld current is decreased rapidly, after which normal weld power is resumed.

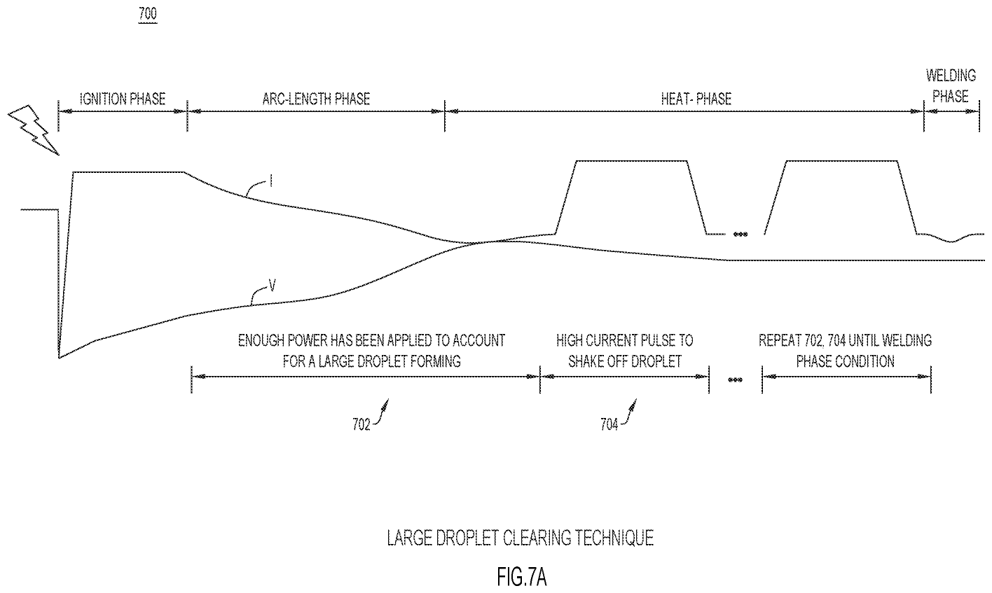

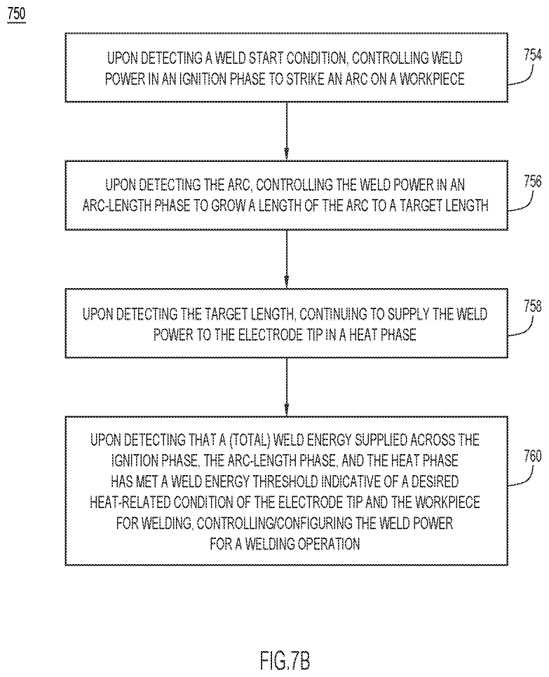

FIG. 7A shows waveforms for current I and voltage V for an example large droplet clearing technique 700. At 702, a large droplet forming at the electrode tip is detected. In response, at 704, a high current pulse is applied to the electrode to release the droplet. The process repeats 702 and 704 for each subsequent droplet that forms.

FIG. 7B is a flowchart of an example method 750 of performing a start of weld procedure in a welding or cutting system having a power supply to supply weld power to a consumable electrode tip extending from a welding torch. Throughout the start of weld procedure, a PSC monitors/measures weld current and/or weld voltage of the weld power supplied by the power supply to the electrode tip/welding torch, and controls the power supply to control the weld power based on the measurements in order to implement the successive phases of the start of weld procedure.

Operation 754 includes, upon detecting a weld start condition, controlling the weld power (e.g., rapidly increasing the weld current) in an ignition phase to strike an arc on a workpiece. Operation 754 may include, prior to detecting the weld start condition, measuring a voltage indicative of a weld voltage of the weld power, computing a time derivative of the voltage to produce a voltage derivative, and detecting that the voltage derivative falls below a voltage derivative threshold indicative of contact between the torch or the electrode tip and the workpiece.

Operation 756 includes, upon detecting the arc, controlling the weld power (e.g., increasing the weld voltage) in an arc-length phase to grow a length of the arc to a target length. Detecting the arc may include detecting that the voltage indicative of the weld voltage exceeds a first voltage threshold indicative of the arc.

Operation 758 includes, upon detecting the target length, continuing to supply the weld power to the electrode tip in a heat phase. Detecting that the length of the arc has attained the target length may include detecting that the voltage exceeds a second voltage threshold indicative of the target length and that is greater than the first threshold.

Operation 760 includes, upon detecting that the (total) weld energy supplied across the ignition phase, the arc-length phase, and the heat phase has attained or exceeded a weld energy threshold indicative of a desired heat-related condition of the electrode tip and the workpiece for welding (i.e., when such condition is detected), controlling the weld power for a welding operation. The detecting may include integrating the weld energy across the ignition phase, the arc-length phase, and the heat phase to produce an accumulated/integrated weld energy, and comparing the integrated weld energy against the weld energy threshold. The desired heat-related condition includes a desired temperature or a desired melt condition of the electrode tip and the workpiece, as described above. Controlling the weld power for the welding operation may include controlling the power supply to supply weld current and voltage waveforms for performing a MIG/MAG welding operation. After the start of weld procedure has been performed, successive welding operations may be performed without the start of weld procedure.

In summary, operations 754-760 collectively include, upon detecting the weld start condition, performing the start of weld procedure that includes sequential phases of controlling the weld power to strike the arc on the workpiece, grow the length of the arc to the target length, and heat the electrode tip and the workpiece until the weld energy supplied to the electrode tip across the sequential phases reaches the weld energy threshold indicative of the desired heat-related condition of the electrode tip and the workpiece for welding. When the weld energy reaches the weld energy threshold, controlling the weld power for a welding operation.

Method 750 may further include, during the sequential phases, upon detecting that undesired molten droplets have formed on the electrode tip, pulsing the weld current to release the undesired molten droplets from the electrode tip.

Method 750 may further include, during the sequential phases, upon detecting an undesired short-circuit between the electrode tip and the workpiece, increasing the weld current rapidly to melt the electrode tip and clear the undesired short-circuit.

With reference to FIG. 8, there is a block diagram of an example PSC (also referred to as a “controller”) 104. PSC 104 includes a processor 812 (e.g., a microcontroller) (which may be implemented in hardware, software, or a combination thereof), a memory 814, a clock generator 816, an HMI 817, and PWM drivers 818 coupled with each other. HMI 817 may include a display to present information, an alphanumeric keypad through which an operator may enter information, and switches or press buttons (e.g., an ON/OFF user switch and the like) through which the operator may interact with welding system 100. PSC 104 receives sensed voltage and current (i.e., voltage and current measurements), and weld power settings, and generates PWM waveforms 210 to control the current and voltage waveforms produced by power supply 102 responsive to the PWM signals. Memory 814 stores non-transitory computer readable program instructions/logic instructions 820 that, when executed by processor 812, cause the controller to perform the operations described herein. Memory 814 also stores data 822 used and produced by processor 812. Clock generator 816 generates clocks and timing signals used to drive other components of PSC 104. In embodiments, components of PSC 104 may include electronic circuitry such as, for example, programmable logic circuitry, field-programmable gate arrays (FPGA), or programmable logic arrays (PLA) to execute the computer readable program instructions, which may include microcode, firmware, and so on.

In some aspects, the techniques described herein relate to a method performed by a welding or cutting system having a power supply to supply weld power to an electrode tip extending from a welding torch, including: upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and when the weld energy reaches the weld energy threshold, performing a welding operation on the workpiece.

In some aspects, the techniques described herein relate to a method, wherein the desired heat-related condition includes a desired temperature or a desired melt condition of the electrode tip and the workpiece.

In some aspects, the techniques described herein relate to a method, wherein the sequential phases include: upon detecting the weld start condition, controlling the weld power in an ignition phase to strike the arc on the workpiece; upon detecting the arc, controlling the weld power in an arc-length phase to grow the length of the arc to the target length; and upon detecting the target length, continuing to supply the weld power to the electrode tip in a heat phase.

In some aspects, the techniques described herein relate to a method, wherein: controlling the weld power in the ignition phase includes rapidly increasing a current of the weld power to strike the arc on the workpiece; controlling the weld power in the arc-length phase includes increasing a voltage of the weld power; and continuing to supply the weld power to the electrode tip in the heat phase including supplying the weld power at a substantially constant voltage.

In some aspects, the techniques described herein relate to a method, further including: measuring a voltage indicative of a weld voltage of the weld power; and wherein detecting the arc includes detecting that the voltage exceeds a first threshold indicative of the arc; wherein detecting the target length includes detecting that the voltage exceeds a second threshold indicative of the target length and that is greater than the first threshold.

In some aspects, the techniques described herein relate to a method, further including: upon detecting that the weld energy supplied across the ignition phase, the arc-length phase, and the heat phase reaches the weld energy threshold, controlling the weld power for the welding operation.

In some aspects, the techniques described herein relate to a method, wherein detecting that the weld energy reaches the weld energy threshold includes: integrating the weld energy across the ignition phase, the arc-length phase, and the heat phase to produce an integrated weld energy; and comparing the integrated weld energy against the weld energy threshold.

In some aspects, the techniques described herein relate to a method, further including: measuring a voltage indicative of a weld voltage; wherein detecting the weld start condition includes detecting the weld start condition based on the voltage.

In some aspects, the techniques described herein relate to a method, further including: computing a time derivative of the voltage to produce a voltage derivative, wherein detecting the weld start condition includes detecting that the voltage derivative falls below a voltage derivative threshold indicative of contact between the workpiece and the welding torch or the electrode tip.

In some aspects, the techniques described herein relate to a method, wherein: controlling the weld power for the welding operation includes generating the weld power for a metal inert gas (MIG) or a metal active gas (MAG) (MIG/MAG) welding operation.

In some aspects, the techniques described herein relate to a method, wherein: performing the welding operation includes controlling voltage and current waveforms of the weld power for one of short-arc, spray-arc, or pulsed welding.

In some aspects, the techniques described herein relate to a method, further including, during the sequential phases: upon detecting that undesired molten droplets have formed on the electrode tip, pulsing a weld current of the weld power to release the undesired molten droplets from the electrode tip.

In some aspects, the techniques described herein relate to a method, further including, during the sequential phases: upon detecting an undesired short-circuit between the electrode tip and the workpiece, increasing a weld current of the weld power rapidly to melt the electrode tip and clear the undesired short-circuit.

In some aspects, the techniques described herein relate to a welding or cutting system including: a power supply to supply weld power to an electrode tip of a welding torch; and a controller to control the weld power supplied by the power supply, wherein the controller is configured to perform: upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and when the weld energy reaches the weld energy threshold, performing a welding operation on the workpiece.

In some aspects, the techniques described herein relate to a welding or cutting system, wherein the desired heat-related condition includes a desired temperature or a desired melt condition of the electrode tip and the workpiece.

In some aspects, the techniques described herein relate to a welding or cutting system, wherein the controller is configured to perform, for the sequential phases of controlling the weld power: upon detecting the weld start condition, controlling the weld power in an ignition phase to strike the arc on the workpiece; upon detecting the arc, controlling the weld power in an arc-length phase to grow the length of the arc to the target length; and upon detecting the target length, continuing to supply the weld power to the electrode tip in a heat phase.

In some aspects, the techniques described herein relate to a welding or cutting system, wherein the controller is configured to perform: controlling the weld power in the ignition phase by rapidly increasing a current of the weld power to strike the arc on the workpiece; controlling the weld power in the arc-length phase by increasing a voltage of the weld power; and continuing to supply the weld power to the electrode tip in the heat phase by supplying the weld power at a substantially constant voltage.

In some aspects, the techniques described herein relate to a welding or cutting system, wherein the controller is further configured to perform measuring a voltage indicative of a weld voltage of the weld power, and the controller is configured to perform: detecting the arc by detecting that the voltage exceeds a first threshold indicative of the arc, and detecting the target length by detecting that the voltage exceeds a second threshold indicative of the target length and that is greater than the first threshold.

In some aspects, the techniques described herein relate to a welding or cutting system, wherein the controller is further configured to perform: upon detecting that the weld energy supplied across the ignition phase, the arc-length phase, and the heat phase reaches the weld energy threshold, controlling the weld power for the welding operation.

In some aspects, the techniques described herein relate to a welding or cutting system, wherein the controller is configured to perform detecting that the weld energy reaches the weld energy threshold by: integrating the weld energy across the ignition phase, the arc-length phase, and the heat phase to produce an integrated weld energy; and comparing the integrated weld energy against the weld energy threshold.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method performed by a welding or cutting system having a power supply to supply weld power to an electrode tip extending from a welding torch, comprising:
upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and
when the weld energy reaches the weld energy threshold, performing a welding operation on the workpiece.

2. The method of claim 1, wherein the desired heat-related condition includes a desired temperature or a desired melt condition of the electrode tip and the workpiece.

3. The method of claim 1, wherein the sequential phases include:
upon detecting the weld start condition, controlling the weld power in an ignition phase to strike the arc on the workpiece;
upon detecting the arc, controlling the weld power in an arc-length phase to grow the length of the arc to the target length; and
upon detecting the target length, continuing to supply the weld power to the electrode tip in a heat phase.

4. The method of claim 3, wherein:
controlling the weld power in the ignition phase includes rapidly increasing a current of the weld power to strike the arc on the workpiece;
controlling the weld power in the arc-length phase includes increasing a voltage of the weld power; and
continuing to supply the weld power to the electrode tip in the heat phase including supplying the weld power at a substantially constant voltage.

5. The method of claim 3, further comprising:
measuring a voltage indicative of a weld voltage of the weld power; and
wherein detecting the arc includes detecting that the voltage exceeds a first threshold indicative of the arc;
wherein detecting the target length includes detecting that the voltage exceeds a second threshold indicative of the target length and that is greater than the first threshold.

6. The method of claim 3, further comprising:
upon detecting that the weld energy supplied across the ignition phase, the arc-length phase, and the heat phase reaches the weld energy threshold, controlling the weld power for the welding operation.

7. The method of claim 6, wherein detecting that the weld energy reaches the weld energy threshold includes:
integrating the weld energy across the ignition phase, the arc-length phase, and the heat phase to produce an integrated weld energy; and
comparing the integrated weld energy against the weld energy threshold.

8. The method of claim 1, further comprising:
measuring a voltage indicative of a weld voltage;
wherein detecting the weld start condition includes detecting the weld start condition based on the voltage.

9. The method of claim 8, further comprising:
computing a time derivative of the voltage to produce a voltage derivative,
wherein detecting the weld start condition includes detecting that the voltage derivative falls below a voltage derivative threshold indicative of contact between the workpiece and the welding torch or the electrode tip.

10. The method of claim 1, wherein:
controlling the weld power for the welding operation includes generating the weld power for a metal inert gas (MIG) or a metal active gas (MAG) (MIG/MAG) welding operation.

11. The method of claim 1, wherein:
performing the welding operation includes controlling voltage and current waveforms of the weld power for one of short-arc, spray-arc, or pulsed welding.

12. The method of claim 1, further comprising, during the sequential phases:
upon detecting that undesired molten droplets have formed on the electrode tip, pulsing a weld current of the weld power to release the undesired molten droplets from the electrode tip.

13. The method of claim 1, further comprising, during the sequential phases:
upon detecting an undesired short-circuit between the electrode tip and the workpiece, increasing a weld current of the weld power rapidly to melt the electrode tip and clear the undesired short-circuit.

14. A welding or cutting system comprising:
a power supply to supply weld power to an electrode tip of a welding torch; and
a controller to control the weld power supplied by the power supply, wherein the controller is configured to perform:
upon detecting a weld start condition, performing a start of weld procedure that includes sequential phases of controlling the weld power to strike an arc on a workpiece, grow a length of the arc to a target length, and heat the electrode tip and the workpiece until a weld energy supplied to the electrode tip across the sequential phases reaches a weld energy threshold indicative of a desired heat-related condition of the electrode tip and the workpiece for welding; and
when the weld energy reaches the weld energy threshold, performing a welding operation on the workpiece.

15. The welding or cutting system of claim 14, wherein the desired heat-related condition includes a desired temperature or a desired melt condition of the electrode tip and the workpiece.

16. The welding or cutting system of claim 14, wherein the controller is configured to perform, for the sequential phases of controlling the weld power:
upon detecting the weld start condition, controlling the weld power in an ignition phase to strike the arc on the workpiece;
upon detecting the arc, controlling the weld power in an arc-length phase to grow the length of the arc to the target length; and
upon detecting the target length, continuing to supply the weld power to the electrode tip in a heat phase.

17. The welding or cutting system of claim 16, wherein the controller is configured to perform:
controlling the weld power in the ignition phase by rapidly increasing a current of the weld power to strike the arc on the workpiece;
controlling the weld power in the arc-length phase by increasing a voltage of the weld power; and
continuing to supply the weld power to the electrode tip in the heat phase by supplying the weld power at a substantially constant voltage.

18. The welding or cutting system of claim 16, wherein the controller is further configured to perform measuring a voltage indicative of a weld voltage of the weld power, and the controller is configured to perform:
detecting the arc by detecting that the voltage exceeds a first threshold indicative of the arc, and
detecting the target length by detecting that the voltage exceeds a second threshold indicative of the target length and that is greater than the first threshold.

19. The welding or cutting system of claim 16, wherein the controller is further configured to perform:
upon detecting that the weld energy supplied across the ignition phase, the arc-length phase, and the heat phase reaches the weld energy threshold, controlling the weld power for the welding operation.

20. The welding or cutting system of claim 19, wherein the controller is configured to perform detecting that the weld energy reaches the weld energy threshold by:
integrating the weld energy across the ignition phase, the arc-length phase, and the heat phase to produce an integrated weld energy; and
comparing the integrated weld energy against the weld energy threshold.
